(19) United States
(12) Patent Application Publication
(10) Pub. No.: US 2003/0153264 A1
(43) Pub. Date: Aug. 14, 2003

(54) Apparatus and method for obtaining song information about a song from publicly broadcasted information

(75) Inventors: Eriko Osato, San Jose, CA (US); Shoji Kurakake, San Jose, CA (US)

Correspondence Address: BRINKS HOFER GILSON & LIONE, P.O. Box 10395, Chicago, IL, 60610, US

(73) Assignee: DoCoMo Communications Laboratories USA, Inc.

(21) Appl. No.: 10/074,283

(22) Filed: Feb. 11, 2002

(51) Int. Cl. H04H 1/00

(52) U.S. Cl. 455/3.06; 455/3.01; 455/423

(57) ABSTRACT

There is a method of retrieving information of at least one event. There is a recording of at least one time associated with at least one event from a schedule of a plurality of events. There is a monitoring of the at least one event from the schedule of the plurality of events and updating of at least one database with an unscheduled plurality of events that is combined with the schedule of the plurality of events to form a revised schedule of a plurality of events. There is a selection of at least one parameter to retrieve requested information associated with at least one event from the updated at least one database.

### FIELD OF THE INVENTION

This invention relates generally to a system and method that enables a user to obtain information from a communication medium. In particular, the user is able to purchase obtained information as it relates to the communication medium.

### BACKGROUND OF THE INVENTION

People, as consumers, are constantly bombarded with information from communication mediums such as television, radio, print publications and the like. The information that consumers receive may or may not be helpful or wanted by the consumers. If the consumer does receive information about a product from a communication medium that she wants, then she has to go to a store to purchase the product. There are many products that are advertised on communication medium such as clothes, perfume, cars, songs for various artists etc.

If the consumer hears an interesting song during a television show or radio show she has to remember the name of the song, then go to a record store and purchase the song or album. If the person can't remember the song or wants to inquire about the song from the television or radio show, then she must send inquiries about the song to the television or radio show. In response to the inquiries, some television stations answer some of these questions on their web sites. If the songs in question are from a commercial film, then the incentive for workers at television stations to answer the query is very low. The workers at these television stations may forward these inquiries to the commercial film sponsors when the film sponsors receive inquiries they do not respond to the inquiries. Thus, the user is not able to utilize the information received by the communication medium to obtain information about the song or purchase the song.

There was an invention developed that has a U.S. Pat. No. 5,991,737, which is titled “Automated consumer response to publicly broadcast information.” This invention allows a user to receive information related to publicly broadcasted information, however, this invention does not provide the user a way to receive updated information related to publicly broadcasted information.

Therefore, there is a need for an apparatus and system that makes it convenient for a user to obtain information that may be updated, which is related to broadcasted information.

### BRIEF SUMMARY OF THE INVENTION

The present invention is defined by the following claims, and nothing in this section should be taken as a limitation on those claims. There is a method of retrieving information of at least one event. There is a recording of at least one time associated with at least one event from a schedule of a plurality of events. There is a monitoring of the at least one event from the schedule of the plurality of events and updating of at least one database with an unscheduled plurality of events that is combined with the schedule of the plurality of events to form a revised schedule of a plurality of events. There is a selection of at least one parameter to retrieve requested information associated with at least one event from the updated at least one database.

In another aspect of the invention, there is another method of retrieving information of at least one event. There is a recording of at least one time associated with at least one event from a schedule of a plurality of events. There is a monitoring of the at least one event of the schedule of the plurality of events and updating at least one database with an unscheduled plurality of events that is combined with the schedule of the plurality of events to form a revised schedule of a plurality of events. There is a selection of at least one parameter to retrieve at least one electronic message from the updated at least one database.

In yet another aspect of this invention, there is a system for retrieving information on at least one event. The system includes at least one first server, at least one second server and at least one terminal. The at least one first server having at least one database, where information associated with a schedule of a plurality of events is recorded on the at least one database. At least one second server in connection with the at least one first server, where the at least one second server having at least one database that records the information associated with the schedule of the plurality of events and monitors the recorded information associated with the schedule of the plurality of events to update the at least one database with information associated with an unscheduled plurality of events that is combined with the recorded information associated with the schedule of the plurality of events to form a revised schedule of a plurality of events. The at least one terminal in connection with the at least one first server, wherein the at least one terminal selects at least one parameter to retrieve requested information of at least one event from the update of the at least one database.

In yet another aspect of this invention, there is a terminal. There is a means for recording at least one time associated with at least one event from a schedule of a plurality of events. There is a means for selecting at least one parameter to retrieve information associated with the at least one event.

In yet another aspect of this invention there is a database. The database records information associated with a schedule of a plurality of events and monitors the recorded information associated with the schedule of the plurality of events to update the at least one database with information associated with an unscheduled plurality of events that is combined with recorded information associated with the scheduled plurality of events to form a revised schedule of a plurality of events.

### BRIEF DESCRIPTION OF SEVERAL VIEWS OF THE DRAWINGS

FIG. 1 is a simplified graphical representation showing a data communication network in which the present invention finds its application;

FIG. 2 illustrates the features of a typical cellular phone;

FIG. 3 illustrates a communication between a terminal, a music server and a record company server;

FIG. 4A illustrates specific features of the terminal;

FIG. 4B illustrates a functional description of the terminal;

FIG. 5A illustrates a specific feature of the music server;

FIG. 5B illustrates a functional description of the music server;

FIG. 6A illustrates a specific feature of the record company server;

FIG. 6B illustrates a functional description of the record company server;

FIGS. 7A-7D are flow charts illustrating the method for implementing the invention; and

FIG. 8 is a graphical illustration of a display screen.

### DETAILED DESCRIPTION OF THE INVENTION

The present preferred embodiments of the invention are described herein with references to the drawings, wherein like components are identified with the same references. The descriptions of the preferred embodiments contained herein are intended to be exemplary in nature and are not intended to limit the scope of the invention.

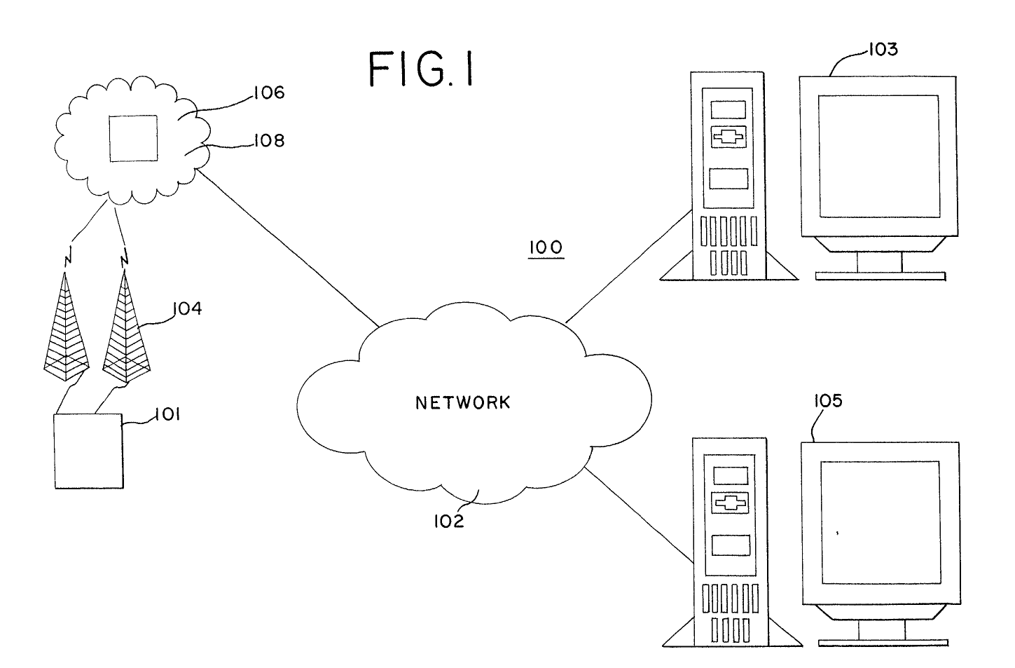

FIG. 1 illustrates graphically an exemplary third generation, wireless mobile access network and Internet Protocol (IP) network 100 or system 100 in which the invention is intended to find application. System 100 comprises: a mobile host 101, a network 102, a music server 103, base transceiver stations (BTS) or access point (AP) 104, a record company server 105, an access network node 106 and a wireless communication network 108. Mobile host 101 may also be referred to as a terminal. Although, one terminal, one music server and one record company server is utilized, this invention may include a plurality of terminals, a plurality of music servers, plurality of networks, a plurality of BTSs, a plurality of Internets and a plurality of record company servers. In addition, the network 102 may include other devices that can communicate with a computer or server such as a printer. The AP 104 is connected to the network 102 through wireless communication network 108 and access network node 106. AP 104 is serving mobile host 101. Mobile host 101 accesses the access network node 106 to receive requested data therefrom through a communication path comprised of the AP 104 and the network 102. Mobile host 101 and AP 104 communicate with each other wirelessly, using time digital multiple access (TDMA), code division multiple access (CDMA), wideband code division multiple access (W-CDMA) or other wireless digital data communication technologies that are standard. Mobile host 101 is a cellular phone but may be a computer or a combination thereof. Mobile host 101 may also be a laptop or notebook computer, a personal digital assistant and the like.

Network 102 supports the Internet addressing and routing protocols. According to these Internet protocols, the mobile host 101, AP 104, music server 103 and record company server 105 in the network 102 has a unique address, called the IP address. To communicate digital data over the network, a sender or source node subdivides the data to be transmitted into “IP packets.” An IP packet includes communication control data, such as the IP addresses of the source node and the intended destination node, and other information specified by the protocol, and substantive data to be passed on to the destination node. A single communication of data may require multiple packets to be created and transmitted depending on the amount of data being communicated and other factors. The source node transmits each IP packet separately, and the packets are routed via intermediary routers in the network from the source node to the destination node. The packets do not necessarily travel to the destination node via the same route, nor do they necessarily arrive at the same time. This is accounted for by providing each packet with a sequence indicator as part of the packetizing process. The sequence indicators permit the destination node to reconstruct the packets in their original order even if they arrive in a different order and at different times, thus allowing the original data to be reconstructed from the packets.

For purposes of the present description, it is assumed that the data network 102 adheres to the International Mobile Telecommunications 2000 (IMT-2000) standards and the specification of the International Telecommunications Union (ITU) for wireless, mobile access networks. The proposed third generation and beyond networks support IP based data communication, i.e., all data is communicated in digital form in IP packets via Internet addressing and routing protocols from end to end. The term mobile host may also be referred to as mobile node. Also, in the proposed third generation and beyond wireless networks, mobile hosts are free to move within the network while remaining connected to the network and engaging in data communication with servers through the Internet. To support mobility of the mobile host 101, the system 100 implements Mobile IP according to the Mobile standards, such as Mobile IP Version 4 (IPv4) and Mobile IP Version 6 (IPv6), proposed by the Internet Engineering Task Force (IETF).

The mobile host 101 through access network node 106 and network 102, may request information from music server 103. In general, terminals are the sites at which a user makes requests for data from computers or servers on the network. Usually, the requested data resides in systems, enterprise computers or servers.

In this specification, the terms “user” and “server” refer to a computer's general role as a requester of data (user) or provider of data (server). In addition, terminals referred to as “systems” refer to computers whose general purpose may be as both requesters of data or providers of data. In general, the size of a terminal or the resources associated with it does not preclude the ability of the terminal to act as a client, server, or system. Further, each terminal may request data in one transaction and provide it in another transaction, thus changing the terminal's role from client to server, or vice versa.

In this case, data or information from the music server 103 is transferred through the network 102 to mobile host 101. Network 102 represents, for example, the Internet, which is an interconnection of networks. In addition, the network may be a local access network, a wireless local, a wide area network, a metropolitan area network, a virtual area network or any network that may be able to facilitate the transfer of data between computers or servers. Furthermore, in traversing the network the data may be transferred through several intermediate servers and many routing devices, such as bridges and routers.

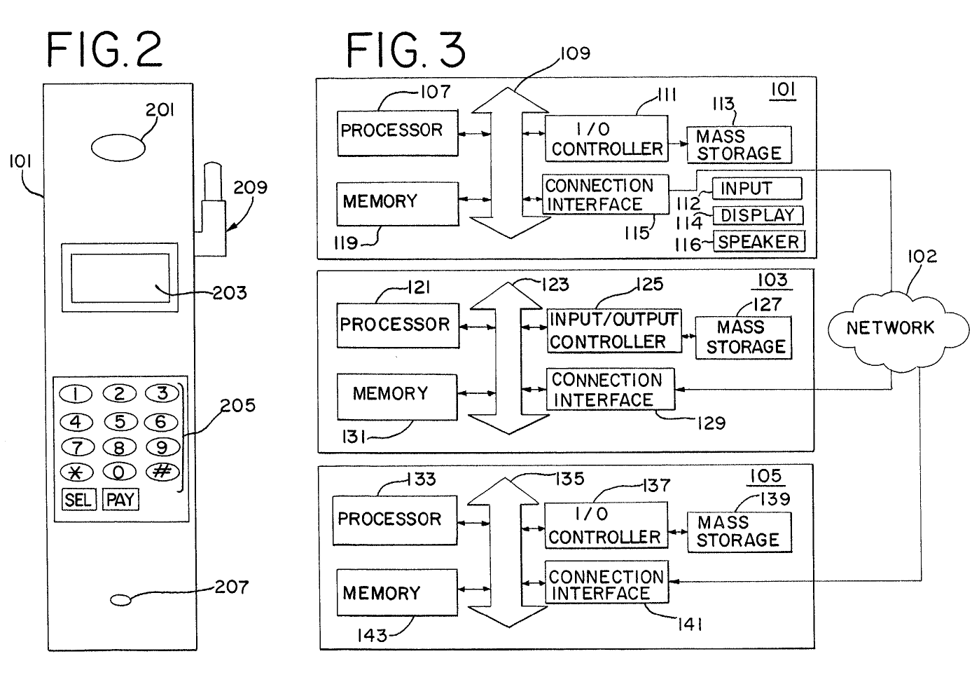

FIG. 2 illustrates the features of a typical cellular phone. This mobile host 101 includes: a speaker 201, a liquid crystal display (LCD) 203, a plurality of function buttons 205, a microphone 207 and an antenna 209. The plurality of function buttons 205 is utilized by at least one user to input information into mobile host 101. Mobile host 101 functions as a normal cellular phone, as known to those of ordinary skill in the art, so a description of the operation of the cellular phone has been omitted. Speaker 201 is equivalent to at least one speaker 116 so these terms may be utilized interchangeably throughout the invention. LCD display 203 is equivalent to a display device 114 so these terms may be utilized interchangeably throughout the invention. Plurality of functions buttons 205 is equivalent to an input device 112 so these terms may be utilized interchangeably throughout the invention.

FIG. 3 illustrates a network containing a terminal, a music server and a record company server. In this example, mobile host 101 is a cellular phone as shown in FIG. 2. However, mobile host 101 may be a computer or any other device that allows two or more users to communicate wirelessly with each other. In this example, mobile host 101 is interconnected wirelessly through network 102 to the music server 103. In addition, the music server 103 is interconnected through network 102 to the record company server 105. Mobile host 101 includes conventional components, such as a processor 107, an Input/Output (I/O) controller 111, a wireless connection interface 115, a memory 119, an input device 112, a display device 114 and at least one speaker 116. The processor 107, memory 119, I/O controller 111, and the wireless connection interface 115 are interconnected through a bus 109. The wireless connection interface 115 comprises at least one data buffer, at least one channel coder, at least one modulator, at least one interleaver, at least one puncturer, at least one transmitter, at least one multiplexer, at least one receiver and other devices associated with a wireless connection interface.

Mass storage device 113 is interconnected to the system through I/O controller 111. Input device 112 can be a keyboard, mouse, touch screen, graphical user interface or any other device or method that can be utilized as an input device. Display device 114 is any type of conventional display that may have a Liquid Crystal Display (LCD). Speaker 116 may be any type of conventional speaker. Connection interface 115 provides an operative connection to connect mobile host 101 to network 102 in compliance with the necessary data communication protocols.

Music server 103 includes conventional components, such as a processor 121, an I/O controller 125, a connection interface 129 and a memory 131. The processor 121, memory 131, I/O controller 125 and the connection interface 129 are interconnected through a bus 123. The connection interface 129 comprises the same devices as in connection interface 115. Mass storage device 127 is interconnected through I/O controller 125 to the bus 123. The architecture illustrated in music server 103 is typical for a personal computer “PC” type, although any type of computer capable of operating as a server. Even though it is not shown, music server 103 may also include: an input device and a display device as in mobile host 101. The term music server or computer is applicable to any type of server that is capable of having a database for the storage of information. Connection interface 129 provides an operative connection to connect music server 103 to the network 102 in compliance with the necessary data communication protocols. Music server 103 may also be a conventional server that can receive requests from mobile host 101 to provide mobile host 101 with products such as clothing, perfume, cars, etc from record company server 105.

Record company server 105 includes conventional components, such as a processor 133, an I/O controller 137, a connection interface 141 and a memory 143. The processor 133, memory 143, I/O controller 137 and the connection interface 141 are interconnected through a bus 135. Mass storage device 139 is interconnected through I/O controller 137 to the bus 135. The connection interface 141 comprises the same devices as in connection interface 115. The architecture illustrated in record company server 105 is typical for a personal computer “PC” type, although any type of computer capable of operating as a server. Even though it is not shown, record company server 105 may also contain an input device, a display device and at least one speaker as in mobile host 101. The term record company server or computer is applicable to any type of server that is capable of having a database for the storage of information. Record company server 105 may also be a conventional server that can receive requests from mobile host 101 through music server 103 to provide mobile host 101 with products such as clothing, perfume, cars, etc. Record company server 105 may also be considered be a server for a department store, retail store that normally has an inventory of products such as clothing, perfume, cars, etc.

Connection interface 141 provides an operative connection to connect the record company server 105 to the network 102 in compliance with the necessary data communication protocols. It will be appreciated from the description below, that the present invention may be implemented in a software program, which is stored as executable instructions on a computer readable medium on the client server and systems, such as mass storage devices 113, 127 and 139, respectively or in memories 114, 131 and 143 respectively.

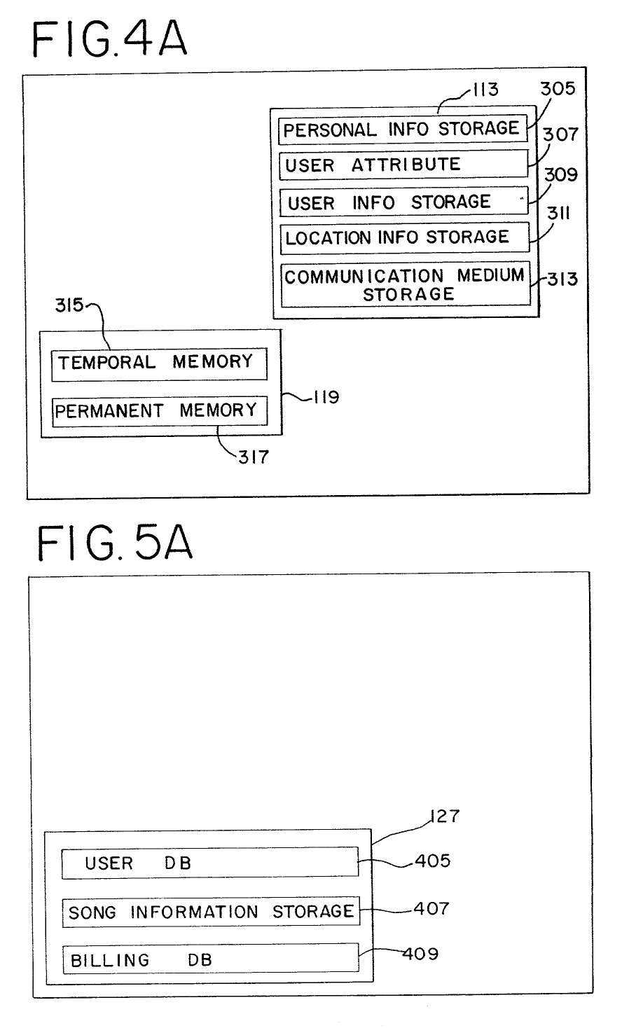

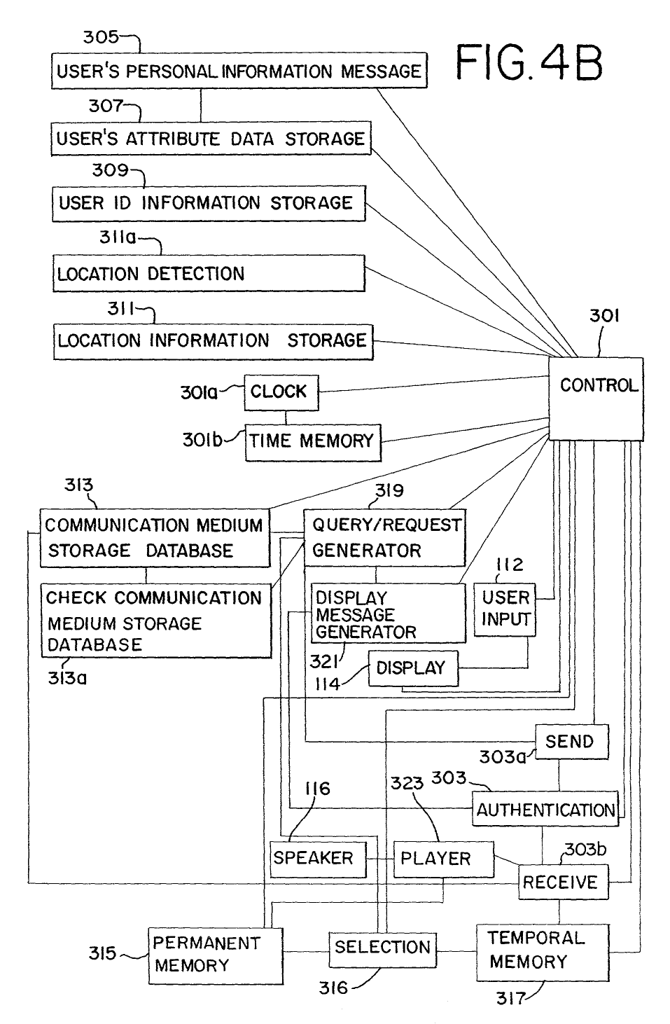

FIG. 4A illustrates specific features of the terminal. The specific features are: the mass storage device 113 and the memory 119. Mass storage device 113 includes magnetic disk drives, single in-line memory module (SIMM) or magneto-optical disk drives. SIMM is a module containing one or several random access memory (RAM) chips on a small circuit board with contact pins that connect a computer motherboard. In alternative embodiments, however, other storage systems may be used, such as bubble memory, flash memory, or systems using other storage technologies. Mass storage device 113 also includes: a personal information storage database 305, user attribute information database 307, user identification storage database 309, location information storage database 311 and communication medium information storage database 313. Personal information storage database 305 includes: at least one name of at least one user, at least one address of at least one user, at least one phone number of at least one user, at least one email address of at least one user, at least one gender of at least one user, at least one date of birth of at least one user and any other information associated with personal information of a user.

User attribute information storage database 307 includes: at least one gender of at least one user, at least one date of birth of at least one user and other information associated with typical attribute information of at least one user. User identification (ID) information storage database 309 includes: at least one address associated with mobile host 101 such as a serial number, at least one Internet Protocol Layer 3 address of mobile host 101, at least one adapter address Layer 2 address of mobile host 101, at least one password for mobile host 101 and any other information that may be considered user identification information. Those of ordinary skill in the art recognize there are many types of addresses that may be associated with a cellular phone, which may also be included in user identification information storage database 309.

Location information storage database 311 includes: at least one city of at least one user, at least one state of at least one user, at least one country of at least one user, at least one zip code of at least one user or any information that identifies where the at least one user may be located. For example, when the user purchases mobile host 101 and upon first activating mobile host 101 the user may input his location such as Chicago, Ill. into mobile host 101. After a period of time the location information storage database 311 may be changed based on the location of the user, so the location information storage may be a location list including Chicago, Ill., New York, N.Y. and San Francisco, Calif. etc depending on where the at least one user is located when utilizing the process described by this invention.

Communication medium storage database 313 includes: at least one location area or at least one location area list from the location information storage database 311, at least one type of service medium list or at least one type of service medium and at least one television and/or radio station name list or at least one television and/or radio station name list. The type of service medium may be broadcast television, cable, digital, radio station, a publication and the like. For instance, a broadcast station can be DIRECTV®, AT&T® Broadband Cable, or the NEW YORK TIMES®. An example of communication medium storage 311 may be San Francisco, Broadcast TV, KTSF station.

Memory 119 is a typical memory that has a Random Access Memory (RAM). Memory 119 also includes a storage space for temporal memory 315 and permanent memory 317. Temporal memory 315 is temporary storage space for information that can be accessed by mobile host 101 for a relatively short period of time. Permanent memory 317 is a permanent storage space that can be accessed by mobile host 101 at any period of time. Those of ordinary skill in the art recognize the terms temporal memory and permanent memory so a description of temporal memory and permanent memory are omitted.

FIG. 4B illustrates a functional description of the terminal or the mobile host 101. A control 301 and an authentication 303 or authenticate 303 is included in processor 107. Control 301 is utilized in mobile host 101 to process information associated with mobile host 101. Authentication 303 is utilized to authenticate mobile host 101. In processing information utilized by mobile host 101, control 301 has a number of functionalities. First, control mechanism 301 processes information by utilizing a sending mechanism 303a to send communication from mobile host 101 to music server 103. Next, control 301 processes information by utilizing a receiving mechanism 303b to receive communication from music server 103. Communication may be any type of information or at least one message in a format that can be transmitted from a terminal to a computer or server and vice versa, such as a format known as Internet Protocol language that may be Hypertext Markup Language (HTML), Extensible Markup Language (XHTML), electronic messaging, electronic mail, electronic mail text-messaging and the like.

The information sent through sending mechanism 303a and received by receiving mechanism 303b may be transmitted through authentication 303 to determine if the information can be sent or received from mobile host 101. The operation of authenticate 303 is described later.

Control 301 also processes information in mass storage device 103 through the bus 109. Control mechanism 301 is able to access and process storage information in user personal information storage database 305, user attribute data storage database 307, user ID information storage database 309, location information storage database 311 and communication medium storage database 313. For example, as a response to instructions or input from input device 112 or plurality of functions buttons 205, control mechanism 301 is able to check 313a communication medium storage database 313 for communication medium information. Location detection 311a may be utilized to detect a location of the user and stored in location information storage database 311.

In addition, control 301 communicates with a clock device 301a to activate and deactivate clock device 301a. Control 301 is in communication with time memory 301b through clock device 301a where any memory related to clock device 301a can be saved in time memory 301b.

A query or request generator 319, a display generator 321, the input device 112, and the display 114 or the display 203 are in communication with each other through control 301. The at least one speaker 116 or speaker 201 is in communication with control 301 through receiving mechanism 303b and authenticate 303. A player 323 is in communication with control 301. Input device 112 utilizes control 301 to utilize selection 316 to receive communication in permanent memory 315 and/or temporal memory 317. Even though control 301 is utilized to operate and access all the devices in FIG. 4b these devices do not have to be in communication with control 301 to be operable in this invention. The description in FIG. 4b is only a functional description of how the devices in mobile host 101 operates it is not a limiting description of this invention.

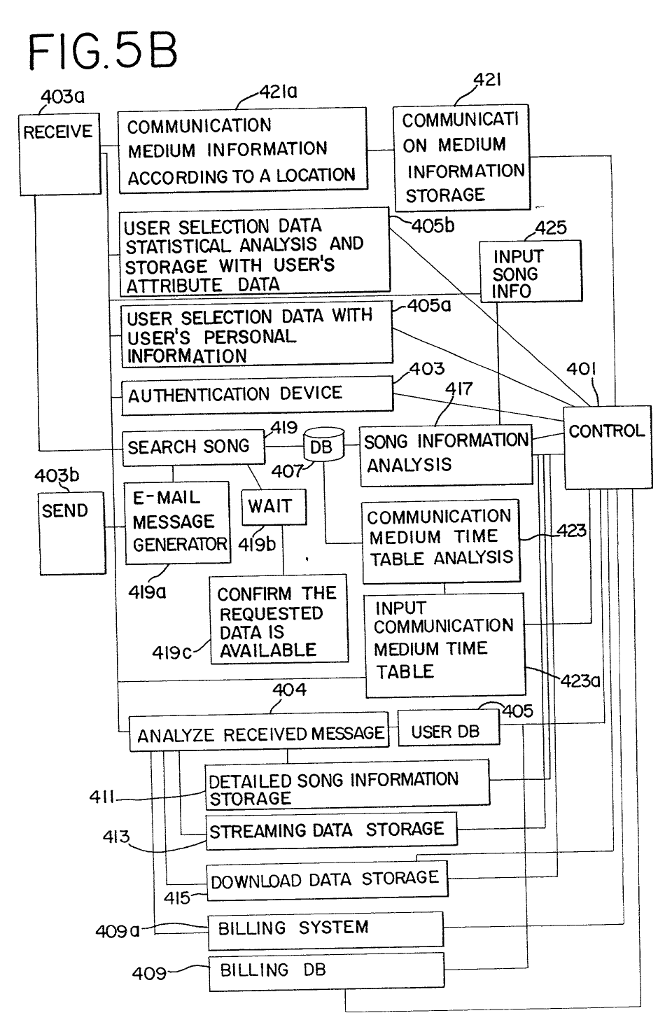

FIG. 5A illustrates a specific feature of the music server. The specific feature is the mass storage device 127. Mass storage device 127 includes an equivalent storage system as described in mass storage device 113. Mass storage device 127 also includes: a user database 405, at least one song information database 407 and a billing information database 409. User database 405 includes any information related to a user who accesses information from the music server such as personal information from personal information storage 305, user ID from user ID information storage 309, at least one credit history of a user, at least one billing address of a user and any other information related to the user.

Billing information database 409 includes: credit card information for a user or mobile host 101, user ID information for mobile host 101, payment authorization for mobile host 101, electronic funds transfer information for mobile host 101, a check routing number for a user or mobile host 101, when the user purchases at least one song or at least one album or at least one product, which song, album or product was purchased, an amount due for the song, album or product and any other information related to billing information. Music server 103 through input song information 425 receives an update of information related to requested information and processes song information in song information analysis 417 and stores the song information in song information database 403. Input song information 425 comes from record companies.

Information relating to songs is on song information database 407 which includes: at least one name of at least one artist, at least one title of at least one song, at least one title of at least one album having the at least one song, at least one communication medium time table, at least one link to a sample of at least one song or at least one album having the at least one song associated with the communication medium time table, at least one link to at least one price of at least one song associated with the communication medium time table, at least one link to at least one price of at least one album having the at least one song associated with the communication medium time table, at least one link to at least one streaming media data related to at least one song associated with the communication media time table, at least one link to at least one streaming media data related to at least one album having the at least one song associated with the communication medium time table, and at least one link to more information and any other information that is related to song information. Song information database 407 may also include product information or catalogue information such as size, type, color, price, number of products available, name of product and any other product related information that a user may utilize to learn about a product and/or purchase a product.

Music server 103 receives song information through receiving mechanism 403a from sending mechanism 501a of record company server 105. Streaming media is the transfer of video and audio to users across a network, where the streaming media is received as continuous real-time stream information. A television and/or radio time table information provider, television and/or radio station may input communication medium time table information 423a into the communication medium time table of song information database 407, where the song information is combined with communication medium time table to form Table 1, later described. At least one television show or at least one radio show, or any type of publicly broadcasted event as utilized in this invention may also be referred to as at least one event.

The time table information in song information database 407 may be a television, radio, print publication schedule and the like. The time table information contains detailed information about the time a television and/or radio show starts and ends. The time table information may be referred to as a schedule of a plurality of events or information associated with a schedule of a plurality of events that is provided to music server 103 by record company server 105. The schedule of plurality of events or information associated with a schedule of a plurality of events is a description of events that are occurring such as scheduled television shows that describes when the event or television is going to occur and what is going to occur during the event or television show and other information associated with the schedule of the plurality of events.

This schedule of a plurality of events or time table information may be updated by record company server 105 to obtain an unscheduled plurality of events or information associated with an unscheduled plurality of events as it monitors communication medium such as television, radio, print publication and the like. The unscheduled plurality of events is an update to the schedule of the plurality of events that describes what actually occurs during the schedule of the plurality of events. The unscheduled plurality of events may be combined with the scheduled plurality of events to form a revised schedule of a plurality of events or information associated with a revised schedule of a plurality of events. The revised schedule of the plurality of events or the unscheduled plurality of events may be transmitted from record company server 105 through sending mechanism 501a to receiving mechanism 403a, so that music server 103 has a constant access to updated time table information or revised scheduled of the plurality of events or the unscheduled plurality of events.

At least one television show or at least one radio show or any type of publicly broadcasted event or at least one occasion when the user is able to receive information that may be recorded on mobile host 101 and accessed at music server 103 and/or record company server 105 is referred to as at least one event from a schedule of a plurality of events. The time table information or a schedule of a plurality of events also includes: a title of the at least one event, a channel of the at least one event, a description of the at least one event, at least one name of at least one song or at least one album performed during the event time period, at least one artist of the at least one song that performed during the event time period, at least one artist of at least one album that performed during the event period, at least one title of the at least one song or the at least one album that is played during the event, a time the at least one song was played during the event and any other information related to a time table schedule. An example of a time table or a schedule of a plurality of events is shown below in Table 1.

TABLE I

| | | | | | |
|---|---|---|---|---|---|
| 8:00 pm | 8:30 pm | 9:00 pm | 9:30 pm | 10:00 pm | 10:30 pm |

| ABC | Americas Funniest Home Videos | | The Chair CC | 20/20 CC | |
|---|---|---|---|---|---|
| | TVPG, Repeat, CC 8:03 | | | | |
| | “intro” 8:10 “flights” | | | | |
| CBS | JAG TVPG, Repeat, cc | | First Monday | 48 Hours CC | |
| | | | TVPG, CC | | |
| FOX | Dark Angel TV14, CC | | 24 TV14 Repeat, | Local Programming >> | |
| | | | CC 9:35 | | |
| | | | “Goodman” | | |
| | | | 9:44 pm “Misery” | | |
| NBC | Roots: Celebrating 25 | | Dateline NBC CC | Law & Order: Special | |
| | Years TVPG, CC | | | Victims Unit TV14, CC | |
| PBS | Washington | Wall $treet Week | NOW With Bill | Senior | EGG the arts |
| | Week cc | With Louis Rukeyser | Moyers CC | Year | show TVPG, |
| | | CC | | TV14, CC | CC |

This example of the time table is only utilized to illustrate a time table this example does not limit the different types of time tables that may be utilized by this invention. For instance, the ABC station section, which may be at least one event from a schedule of a plurality of events, of the time table between 8 and 9 pm may be blanked out because the ABC station may change the time or change the type of event that will be viewed between 8 and 9 pm. In addition, this ABC station section may also include various times when songs are played such as: at 8:03 pm the song “Intro” was played and/or broadcasted and at 8:10 pm the song “Flights” was played and/or broadcasted during the time interval of 8:00-9:00 pm during the event or during a commercial or anytime therebetween. Further, the FOX television station may also include songs played at various times such as: at 9:35 pm the song “Goodman” was played and/or broadcasted and at 9:44 pm the song “Misery” was played and/or broadcasted during the time interval of 9:00-10:00 pm.

FIG. 5B illustrates a functional description of the specific features of the music server. A control 401 and an authentication 403 or authenticate 403 is included in processor 121. Control 401 is utilized in music server 103 to process information associated with music server 103, record company server 105 and mobile host 101. Authentication 403 is utilized to authenticate mobile host 101. Control 401 is utilized in music server 103 to process information associated with music server 103. In processing information utilized by music server 103, control 401 has a number of functionalities. First, control 401 processes information by utilizing sending mechanism 403b to send communication to mobile host 101 and record company server 105 by the same method as in sending mechanism 303a. Next, control 401 utilizes a receiving mechanism 403a to receive communication from mobile host 101 and record company server 105 by receiving mechanism 303b. For example, music server 103 can receive an analyzed received message 404 through receiving mechanism 403a of control 401. Other portions of music server 103 may utilize this analyzed received message 404.

The information sent by sending mechanism 403b of the music server 103 and received by receiving mechanism 403a may be transmitted through authenticate 403 to determine if the information can be sent or received from music server 103. The operation of authenticate 403 is equivalent to the operation of authenticate 303, which is described later.

Control 401 also processes information in mass storage device 127 through the bus 123. Control 401 is able to access and process storage information in user database 405, song information database 407 and billing database 409. When control 403 receives the analyzed message 404, the control 401 accesses various portions of music server 103.

User database 405 utilizing control 401 is in communication with user selection data with user's personal information 405a, user selection data statistical analysis and storage with user's attribute data 405b and billing database 409. Music server 103 is able to obtain and retain all information associated with the user in user database storage 405 for analysis purposes and billing purposes. Billing database 409 is able to utilize information in user database storage 405 as part of billing system 409a to bill or request payment from a user of mobile host 101.

Control 401 accesses song information database 407 to access information related to a detailed song information storage 411, a streaming data storage 413, a download data storage 415, a song information analysis 417, search for at least one song or at least one album 419, search communication medium information according to a location 421a and a communication time table analysis 423. Detailed song information storage 411, streaming data storage 413 and download data storage 415 acts to provide more information relating to song information database 407. When music server 103 searches for a song 419, control 401 is analyzing the received message 404 from mobile host 101. If the control 401 is able to search for at least one song or at least one album 419 and find the particular information mobile host 101 requires, then an electronic (email) message generator 419a transmits an electronic mail or email message to mobile host 101 through sending mechanism 403b. If control 401 is not able to find at least one song or at least one album in search at least one song or at least one album 419, then music server 103 waits 419b until the record company server 105 inputs song information about the song onto music server 103.

For example, the at least one user may want at least one song in the time slot of 10:00-10:30 am, on Thursday on channel 4 in New Orleans, La., however there is no record of the show on the time table of music server 103. Record company server 105, as described above, continuously monitors television, radio, print publication and the like to find updated information related to the above-mentioned time slot or unscheduled plurality events, which music server 103 has to wait to receive. When record company server 105 does obtain updated song information related to the above-mentioned time slot or unscheduled plurality of events that is combined with the scheduled plurality of events to form a revised schedule of the plurality of events, then record company server 105 through sending mechanism 501a transmits the updated song information or revised scheduled of the plurality of events to input song information 425 of music server 103. Then song information analysis 417 finds at least one time slot in song information database 407 relevant to the inputted updated song information or revised scheduled of the plurality of events and transfers it into the time slot in song information database 407. Then music server 103 accesses this updated song information or revised scheduled of plurality of events and transmits it through sending mechanism 403b to receiving mechanism 303a of mobile host 101.

Next, the music server 103 confirms that the requested information of the search for at least one song or album 419 is available 419c. A television/radio time table information provider, television and/or radio station may input communication medium time table information 423a into the communication medium time table of song information database 407. Communication medium time table analysis 423 accesses timetable information from song information database 407 to provide an analysis of what may be on television and/or radio.

Communication medium information according to a location 421 is accessed by control 401 to search for channel list information or communication medium information according to a particular location 421a. For example, if mobile host 101 communicates with music server 103 to access information related to location information, then music server 103 can utilize the control 401 to find communication medium information or channel list information according to a particular location 421a in communication medium information storage 421 according to a particular location 421a. Even though control 401 is utilized to operate and access all the devices in FIG. 5b these devices do not have to be in communication with control 401 to be operable in this invention. The description in FIG. 5b is only a functional description of how the devices in music server 103 operate it is not a limiting description of this invention.

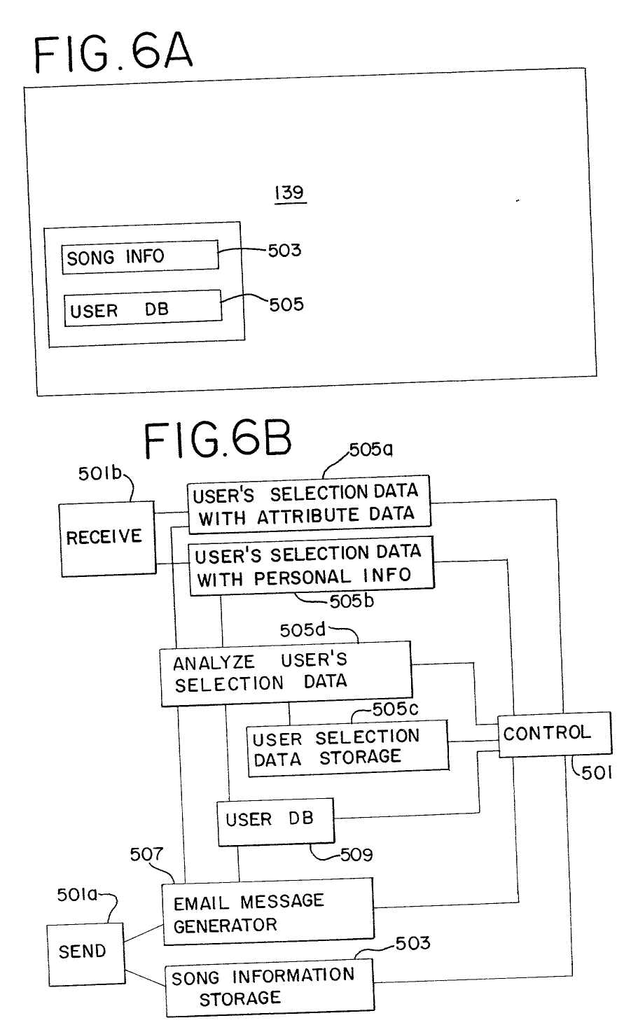

FIG. 6A illustrates a specific feature of the record company server. The specific feature is the mass storage device 139. Mass data storage device 139 includes the same storage system as mass storage device 113. Mass storage device 139 also includes: a song information database 503 and a user information database 505. Song information database 503 includes recorded songs and more information related to song information. Further, the record company server 105 may be a server that includes information related to a department store, where mobile host 101 can access information from music server 103 as it relates to product in record company server 105. Then the mobile host 101 can order products from record company server 105 through music server 103.

The record company server 105, as described above, may monitor communication medium to obtain unscheduled plurality of events or updated information that may be transmitted to music server 103. User information database includes: user selection data analyzed with attribute data 405b and/or user selection data with personal information of user in 405a.

FIG. 6B illustrates a functional description of the specific features of the record company server. A control 501 is included in processor 133, where control 501 is utilized in record company server 105 to process information associated with music server 103 and record company server 105. An authenticator may also be included in processor 133. In processing information utilized by record company server 105, control 501 has a number of functionalities. First, control 501 processes information by utilizing sending mechanism 501a to send a communication or message to music server 103 by the same method as in sending mechanism 303a. Next, control 501 utilizes a receiving mechanism 501b to receive communication or message from music server 103 by the same method utilized by receiving mechanism 303b.

User database storage 505 utilizes control 501 to communicate with user selection data with attribute data 505a and user selection data with personal information 505b. Control 501 utilizes receiving mechanism 501b to receive user selection with attribute data 505a and user's selection data with personal info 505 from sending mechanism 403b of music server 103. Control 501 analyzes user's selection data 505d, of user's selection data with attribute data 404a and user's selection data with personal information 505b, and then stores the user selection data in user database 505 and user selection data storage 505c. Song information storage 503 or song information database 503 is able to utilize sending mechanism 501a to transmit song information to music server 103.

Even though control 501 is utilized to operate and access all the devices in FIG. 6b these devices do not have to be in communication with control 501 to be operable in this invention. The description in FIG. 6b is only a functional description of how the devices in record company server 105 operates it is not a limiting description of this invention.

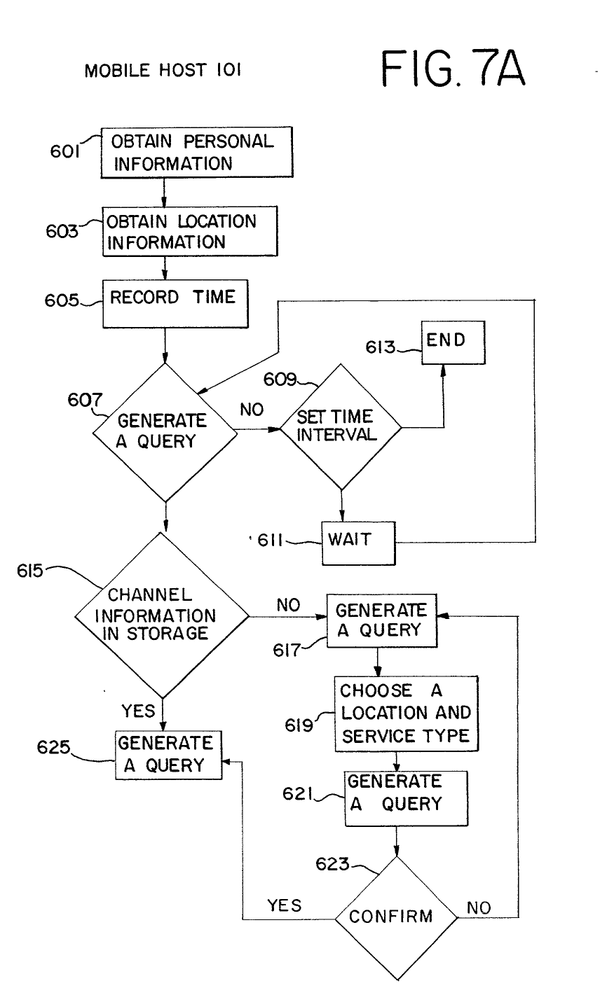

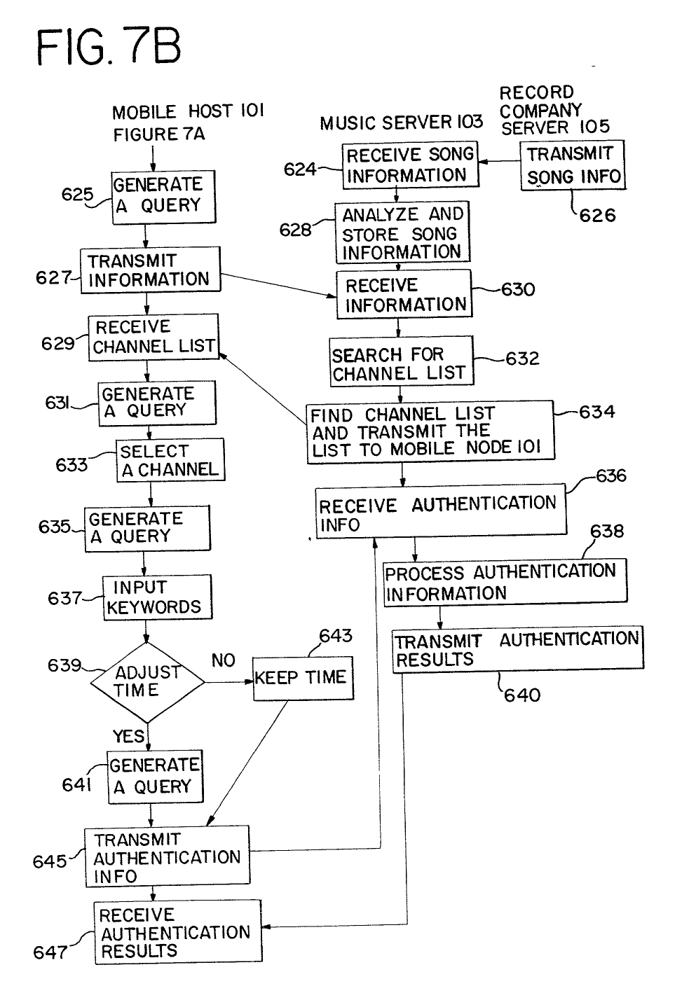

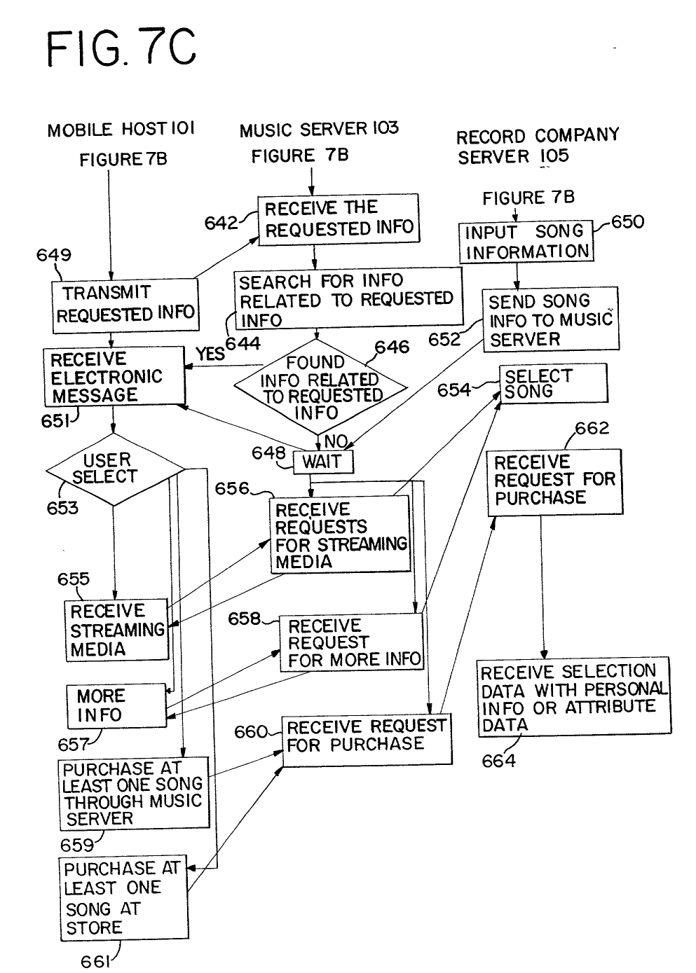

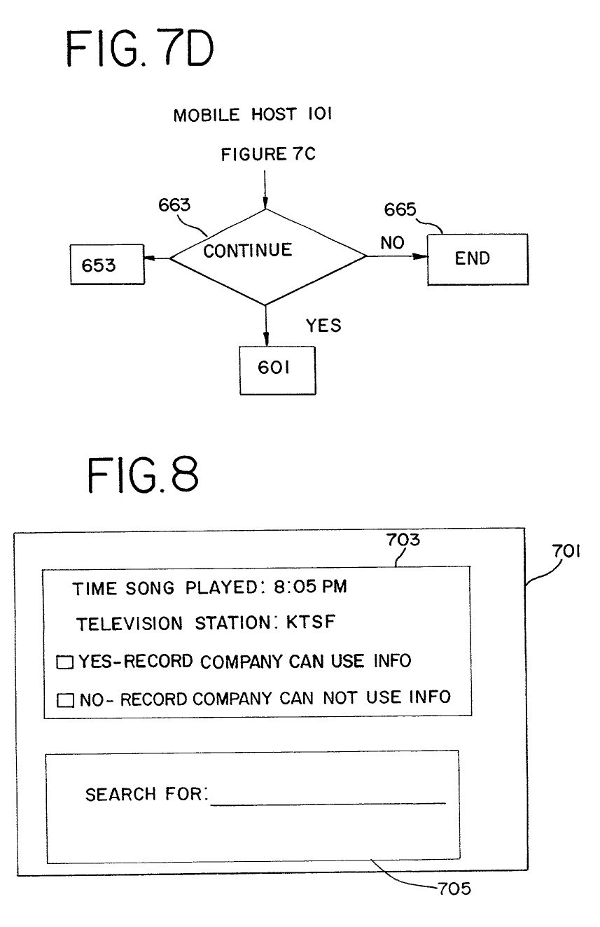

FIG. 7A, is a flow chart illustrating the method for implementing the invention. In beginning this process, at least one user may utilize an authentication procedure before starting this process or software program. The authentication procedure or method for authenticating at least one user at a mobile host 101 shall be described.

The user may be authenticated at mobile host 101 by the following method. Authenticate 303 authenticates the user of mobile host 101 by utilizing biometrics information and/or password identification when the user first activates the mobile host 101. Biometrics is the science and technology of measuring and statistically analyzing biological data. Biometrics usually refers to technologies for measuring and analyzing human body characteristics such as fingerprints, eye retinas and irises, voice patterns, facial patterns, and hand measurements for authentication and/or security purposes. If the user is able to enter a correct password upon activating mobile host 101, then the user can utilize mobile host 101. If the user does not enter a correct password upon activating mobile host 101, then the mobile host 101 deactivates and the authentication process ends.

At least one user through mobile host 101 through an operative connection with at least one network 102 is in communication with at least one music server 103 and at least one record company server 105, as described earlier. In 601, mobile host 101 obtains personal information of at least one user and the personal information is stored in user personal information storage database 305. Personal information, as described above includes: at least one name of at least one user name, at least one address of at least one user, at least one phone number of at least one user, at least one electronic mail address of at least one user etc. The personal information may already be stored in mobile host 101, because the user inputted his or her personal information upon first activating mobile host 101. If mobile host 101 is a computer, then input device 112 is utilized to input personal information into the terminal.

If mobile host 101 is a cellular phone then the user may utilize the plurality of function buttons 205 to input personal information into mobile host 101. In addition, the at least one user may be a subscriber to a special service that allows him to utilize this software program or service of the cellular phone company associated with mobile host 101. In 603 mobile host 101 detects the location of the user by utilizing location information detection device 311a and stores the location information in location information storage 311. The location information detection device detects a location of at least one user in three ways. First, the user may input her location manually into mobile host 101 by utilizing input device 112 or plurality of function buttons 205 when first activating mobile host 101.

Another method for detecting the location of mobile host 101 is to utilize a typical base station transceiver, such as AP 104 in cooperation with network 102 to act in a conventional manner to determine the location of a cellular phone such as mobile host 101. The next method for detecting the location of mobile host 101 is to utilize a conventional global positioning system (GPS) in mobile host 101. The GPS in cooperation with network 102 acts in a conventional manner to determine the location of mobile host 101. The above processes 601 and 603 are preliminary process for collecting information necessary to the features of the present invention. The main process of the present invention begins at 605.

In 605, mobile host 101 waits for the at least one user to record at least one time in which at least one song was broadcasted on a communication medium such as television or radio. For example, a user may be watching a program that is on Jan. 22, 2001 between the hours of time interval 8:00 pm and 9:00 pm, where there is a song the user wants to obtain. In this invention, the at least one song may be at least one product such as clothing, perfume, cars, etc that mobile host 101 learns more about and/or orders from record company server 105 through music server 103. The specific time in which the song may be played during the program and/or commercials is 8:05 pm, which the user may be able to record by utilizing a plurality of function buttons 205 to input the recording time of 8:05 pm into mobile host 101.

The time is measured by clock device 301a and recorded at time memory 301b by utilizing input device 112 or a special button on plurality of function buttons 205. In addition, the user may be able to make a record of any time period in which the song was played during a show and/or at least one commercial. For example, the user may instruct clock device 301a to record a time of a song was played such as a time period of 8:00-8:30 pm, because the user may be unsure of the exact time the song was played during a show or at least one commercial or at least one event of scheduled plurality of events.

In 607, query message generator 319 generates a first query that is displayed by display generator 321 on display 114 or LCD 203. The first query asks the user if the user wants to send the query or question to music server 103. In this first query, the user may be in the middle of a conversation on mobile host 101. In 609, if the at least one user decides not to send the query, then the user chooses the “NO” button on the plurality of functions buttons 205 onto mobile host 101.

In 611, the user may set a time interval to wait before sending the query to music server 103 when the time period passes the process continues to 615. For example, a user may utilize plurality of function buttons 205 to input a time interval of fifteen minutes before sending a query to music server 103. When the fifteen minutes passes then this software program or process continues to 615. In addition, in 613 mobile host 101 may cancel the option to send a query, which ends the process.

In 615, the at least one user decides to send the first query to music server 103, then the at least one user confirms by plurality of function buttons 205 that she wants to send the query, then mobile host 101 through control 301 checks if there is stored television or radio channel information 313a in communication medium storage database 313. Television or radio channel information or channel information, as stated above, includes at least one location area list, at least one type of service medium list and at least one television and/or radio station name list in communication medium storage database 313. Communication medium storage database 313 may include information from a previous inquiry that is pertinent to the at least one user's present location that is part of the channel information. For example, if the user was on vacation in the same location a year before and recorded at least one song from at least one event from a schedule of a plurality of events on mobile host 101, then information such as channel information related to the at least one song is still on mobile host 101.

In 617, there is no channel information in communication medium storage 313, then query request generator 319 generates a second query, which includes at least one location area list in accordance with location information storage 311, and at least one type of service medium list that is displayed on display 203 by display generator 321.

In 619, the user selects at least one location area where the at least one event occurred from the location list and at least one type of service medium the at least one event was broadcasted on from the at least one type of service medium list, which is referred to as information associated with at least one event, from display 203 by utilizing plurality of function buttons 205.

The user may also select at least one of two different parameters: at least one location area where the at least one event occurred from the location list and at least one type of service medium the at least one event was broadcasted on from the at least one type of service medium list. The user may choose one or all two different parameters to retrieve information associated with the at least one event. In 621, query request generator generates a third query that includes the selected information associated with at least one event that is displayed by display generator 321 on display 203, where the user confirms that the information associated with at least one event or two parameters are correct in 623. If the information associated with at least one event is not confirmed or is incorrect, then the process returns to 617, then the process repeats from 617 to 623 until the information associated with at least one event is correct. If the information associated with at least one event is correct, then the process continues to 625.

FIG. 7B is an illustration of a continuation of the flowchart in FIG. 7A. In 625, a fourth query is generated on query/request generator 319 that is displayed by display message generator 321 on display 203. In 627, mobile host 101 utilizes sending mechanism 303a to transmit information associated with at least one event to the music server 103. Before the at least one user sends any information through mobile host 101 to music server 103 an authentication procedure may be utilized to authenticate mobile host 101 at music server 103, if the mobile host 101 and/or music server 103 decide to utilize the authentication procedure or mechanism.

In the authentication procedure, authenticate 303 communicates with music server 103 to authenticate mobile host 101 by two methods. First, music server 103 transmits original information in the form of encrypted data to the mobile host 101. Mobile host 101, if it is the authorized terminal or mobile host 101 utilizes a shared key, because authorized mobile host 101 and music server 103 has the same shared key in storage. When mobile host 101 receives the encrypted data, mobile host 101 decrypts the encrypted data with the shared key and transmits the decrypted data to the music server 103. Music server 103 receives the decrypted data from mobile host 101 and compares it with the original information. If music server 103 determines that the decrypted data is equivalent to the original information, then mobile host 101 is authorized to use this particular program and the music server 103 transmits a “YES” reply to the mobile host 101. The “YES” reply informs mobile host 101 that it can communicate with music server 103 to go to another step in communication with music server 103.

If the music server 103 compares the original information with the decrypted data and the decrypted data is different from the original information, then the music server 103 transmits a “NO” reply to mobile host 101, whereby mobile host 101 is not authorized to utilize music server 103 and communication between mobile host 101 and music server 103 ends.

In the next method, mobile host 101 transmits a password, which is registered at music server 103 when an account is open at the music server 103. Music server 103 analyzes the transmitted password with a password the music server 103 has in storage for authorized mobile host 101. If the transmitted password is equivalent to the password in storage of music server 103, then mobile host 101 receives a “YES” reply from music server 103, which authorizes mobile host 101 to communicate with music server 103 to go to another step in communication with music server 103. If the transmitted password is different from the password in storage of music server 103, then terminal receives a “NO” reply in an electronic notification from music server 103. The “NO” reply signifies that mobile host 101 is not authorized to communicate with music server 103, then the communication between mobile host 101 and music server 103 ends. The messages communicated between mobile host 101 and music server 103 may be in any type of transferable data format utilized by a computer such as Internet Protocol messaging, electronic notification, electronic mail, e-mail text messaging and the like. The Internet Protocol may be in Extensible Hypertext Markup Language (XHTML) and/or a Hypertext Markup Language (HTML) message format. This invention may also utilize conventional authentication procedures utilized by servers and computers.

In 624, music server 103 obtains at least one song information from song information database 503 from record company server 105, in 626, as described above. The song information is analyzed and sorted in a time table analysis and stored, in 628, in song information database 407. In 630, the music server 103 utilizes receiving mechanism 403a to receive the information associated with at least one event. In 632, music server 103 utilizes control 401 to search for a television and/or radio list or at least one channel list or communication medium information according to a particular location 421a in communication medium information storage 421. The channel list includes information associated with the at least one event. The channel list includes, at least one location area list and at least one type of service medium. For example, channel list may include Los Angeles, Calif. is at least one location area and broadcast television is at least one type of service medium. In 634, when the control 401 has found the channel list, the control 401 utilizes sending mechanism 403b to transmit the channel list to mobile host 101. In 629, mobile host 101 utilizes receiving mechanism 303b to receive the channel list from music server 103.

In 631, query request generator 319 generates a fifth query that is displayed on display 203 by display message generator 321. The fifth query includes the channel list from music server 103. In 633, the at least one user utilizes the plurality of function buttons 205 to select at least one channel from the channel list. The selected channel is the channel in which the song has been played or where the product was displayed. For example, a shirt that was advertised on a commercial may be obtained by mobile host 101 from record company server 105 through music server 103.

In 635, query generator 319 generates a sixth query that is displayed on display 203 by display message generator 321. The sixth query includes the time at least song was played on at least one event from a schedule of a plurality of events, the television or radio station name, an indication if the at least one user allows the record company to utilize personal information of the at least one user, at least one email address of the at least one user and a dialog box, which is displayed in FIG. 8. The dialog box accepts input from the user for optional searching functions and display message generator 321 generates messages displayed on display 203.

FIG. 8 is a graphical illustration of a display screen. The display screen is comprised of the sixth query that is generated by display generator 321 on display 203. The display 203 or display 701 comprises at least two screens: screen 703 and screen 705. However, these two screens may be integrated into one screen. In addition, there may be a plurality of colors utilized for the display 701, screen 703 and screen 705. Further, there may be a plurality of screens utilized on display 701. Screen 703 comprises: the period of time at least song was played, such as 8:05 pm, on at least one television or radio show, the name of the television or radio station, such as KTSF, at least one email address of the user (not shown) and indication boxes “YES” or “NO” if the at least one user allows a record company to utilize personal information of the user. The time relates to the time when at least song was put in time memory 301b, in 605, which reflects the time a special button on plurality of function buttons 205 were pushed by the at least one user to start recording the time at least one song was played on a television or radio show and the like. The time also reflects the time when at least one product was displayed on the television and/or radio show. The indication if the at least one user allows the record company to utilize personal information may be a “YES” or “NO” button on plurality of function buttons 205, as shown in screen 703. Screen 705 comprises at least one dialog box that may be a separate screen on display 203, or display 701 where the at least one user may utilize the plurality of function buttons 205 to input keywords such as an artist name, a title, a type of car, a name of car, a commercial message, a type of cosmetics, a name of cosmetics, a name of an airline company or any information that would be helpful to the music server to identify the at least one song or at least one album or at least one product.

Referring to FIG. 7B, in 637, the at least one user utilizes plurality of function buttons 205 to input at least one keyword into the dialog box. Query generator 319 generates a seventh query including the keyword, and then a message is generated on display 205 by display message generator 321 that the user confirms. If the at least one user doesn't confirm the information generated in the seventh query, then the seventh query is modified by the user utilizing the plurality of function buttons 205, which reflects the modification of the seventh query, and another query is generated. The query keeps being generated until at least one user confirms that the query is correct, then the process continues when the query is confirmed.

In 639, after the at least one user determines that the information being transmitted is correct the at least one user may adjust the time interval. The time interval that the at least one user recorded at 605 may be incorrect. At this point the at least one user is able to choose a time period, in 641, in which the at least one song was played on a television and/or radio show. For instance, the at least one user may expand the time from 8:05 pm to a time period of 8:00 pm to 8:40 pm to have a more accurate time when at least one song was played during the at least one event from a schedule of a plurality of events or when the product was exhibited on the event from a schedule of a plurality of events. The at least one user in 643 may also decide not to adjust the time and the process continues.

In 641, query requester generator 319 generates an eighth query that is displayed on display 202 by display message generator 321 this query allows the user to utilize plurality of function buttons 205 to input another time period. In 645, mobile host 101 utilizes sending mechanism 303a to transmit authentication information and user identification information from User ID information storage database 309 to music data server 103. In 636, music server 103 utilizes receiving mechanism 403a to receive authentication information and User ID information from mobile host 101. In 638, control 401 through authenticate 403 processes the authentication information. Authenticate 403 operates as the authentication process described above. In 640, authentication results from authenticate 403 is transmitted through sending mechanism 403b to receiving mechanism 303b in mobile host 101.

In 647, mobile host 101 receives authentication results from music server 103 that is analyzed. If mobile host 101 receives authentication results that indicate mobile host 101 is not authenticated, then this software program or process ends, as described above. If mobile host 101 receives authentication results that indicate mobile host 101 is authenticated, then this software program or process continues.

FIG. 7C is an illustration of a continuation of the flow chart of FIG. 7B. In 649, mobile host 101 transmits the time or period of time at least song was played on the event from the schedule of the plurality of events, the name of the television or radio station, at least one email address of the user (not shown) and an indication if the at least one user allows a record company to utilize personal information of the user, user identification information and may transmit at least one keyword in the dialog box, which is referred to as requested information or information related to at least one selected channel, to music data server 103 through sending mechanism 303a.

In 642, music server 103 through receiving mechanism 403a receives the requested information transmitted from mobile host 101. As a response to the requested information transmitted by mobile host 101, in 644, control 401 searches through song information database 407 for information related to the requested information. In 646, the information related to the requested information may be found in a schedule of a plurality of events or time table information in song information database 407 of music server 103 when it is found at least one electronic message is transmitted to mobile host 101, in 651.

In 648, if control 401 cannot find any requested information associated or related to the at least one event or the schedule of the plurality of events then the device waits 419b. The information may not be present in song information database 407 or in the schedule of the plurality of events or information associated with the schedule of the plurality of events in song information database 407. In 650, at least one record company inputs song information played on television and/or radio stations into record company server 105. This song information is related to the communication medium time table may or may not include the at least song or requested information related to at least one event or an unscheduled plurality of events that includes requested information related to the at least one event that is sent at 652 by sending mechanism 501a to receiving mechanism 403a of music server 103. This information sent by record company server may be referred to as an update of the requested information associated with at least one event or an unscheduled plurality of events containing the requested information related to the at least one event, or information related to an unscheduled plurality of events. The unscheduled plurality of events containing information related to the requested information or information related to an unscheduled plurality of events may be combined with the schedule of the plurality of events to form a revised schedule of a plurality of events or information associated with a revised schedule of a plurality of events.

Music server 103 may wait for a short or long time period to send at least one electronic message or electronic mail about the update of the information related to the requested information or the unscheduled plurality of events containing the information related to the requested information, or information related to an unscheduled plurality of events to mobile host 101. In 648, music server 103 through input song information 425 has received the update of the information related to the requested information and processes song information in song information analysis 417 and stores the song information in song information database 403. Then music server 103 utilizes sending mechanism 403b to send this information, in 651, to receiving mechanism 303b of mobile host 101 as at least one electronic mail.

For example, the NBC station section of the time table between 9 and 10 pm, which may be at least one event from a schedule of a plurality of events, may be blanked out because the NBC station may change the time or change the type of show that will be viewed between 9 and 10 pm. Record company server 105, that is continually monitoring television, radio stations, print publications and the like is able to obtain updated time table information or an unscheduled plurality of events that contains information related to the event or blanked out time interval between 9 and 10 pm, which is then transmitted, in 652, to music server 103. The unscheduled plurality of events may be combined with the schedule of the plurality of events to form a revised schedule of a plurality of events or a revised time table, or an updated schedule of the plurality of events in song information database 407. Music server 103 is then able to utilize sending mechanism 403b to transmit at least one electronic mail (E-mail) of the information related to the requested information or the revised schedule of a plurality of events that is received by receiving mechanism 303b of mobile host 101. The E-mail may include requested information associated with at least one event. The E-mail includes: a link to detailed song information, a link to streaming data storage, a link to downloaded data, a link regarding the at least one song played and/or broadcasted at the user designation television and/or radio station at the time the song was played and/or broadcasted.

In 651, mobile host 101 utilizes receiving mechanism 303b to receive the at least one electronic message from music server 103 that is displayed by display message generator 321 on display device 203. In 653, the at least one user may select to: receive streaming data from song information related 655 to at least one song, receive more information related to at least one song 657, purchase at least one song 659 at record company server 105 and purchase at least one song at a store 661.

In 655, if the at least one user decides to receive streaming data for the at least one song, then mobile host 101 through sending mechanism 303a transmits a request with user identification (ID) from user identification information storage database 309 to music data server 103. The at least one user utilizes the plurality of function buttons 205 to transmit the request for streaming data. In 656, music server 103 through receiving mechanism 403a receives the request for streaming media with User ID from mobile host 101 as an analyzed received message 404. Music server 103 through sending mechanism 403b transmits the requested streaming data in streaming data storage 413 to mobile host 101, which is stored in temporal memory 315. Mobile host 101 through receiving mechanism 303b receives the requested streaming data from music server 103. Control 301 utilizes player device 323 to play the requested streaming data on speaker 201, then the process continues to 653.

In 657, if the at least one user decides to receive more information about the at least one song then the at least one user utilizes the plurality of function buttons 205 to input the request for more information. Mobile host 101 through sending mechanism 303a transmits the request for more information about the at least song with User ID to music server 103. In 658, music server 103 through receiving mechanism 403a receives the request for more information from mobile host 101. Sending mechanism 403b as utilized by music server 103 transmits more detailed information from detailed song information 411 to receiving mechanism 303b of mobile host 101, where the more detailed information is stored in the temporal memory 315, then the process continues to 653.

In 659, if the at least one user decides to purchase the at least one song, then mobile host 101 through sending mechanism 303a transmits a request for purchase of the at least one song with User ID. The user utilizes a special PAY button on a plurality of function buttons 205 to instruct mobile host 101 to purchase the at least one song. In 660, music server 103 through receiving mechanism 403a receives the request to purchase the at least one song, album or product with User ID. Music server 103 accepts the request to purchase the at least one song.

Music server 103 processes the request to purchase the at least one song and transmits the request to purchase the at least one song through sending mechanism 403a to, at 662, receiving mechanism 501b of record company server 105. At 660, control 401 downloads a music file associated with the song in download data storage 415 through sending mechanism 403b to receiving mechanism 303b of mobile host 101, where the music file is stored in the permanent memory 317. Billing system mechanism 409a in communication with user database 405 inputs the transfer of the music file as a transaction between mobile host 101 and music server 103 in user database 405 and billing database 409.

In addition, music server 103 through billing system mechanism 409a charges a commission fee for record company server 105 for the purchase of the music file. If the user requests to purchase at least one product, then the record company server 105 is a server that processes the order through music server 103 by utilizing billing system mechanism 409a, billing database 409 and user database 405 to record the transaction. The user may be able to receive the product through any conventional mailing system, such as United States Postal Service etc.

Based on the information in the requested information in 642, music server 103 knows if the at least one user agreed to allow record companies to utilize the personal information of the user. This information related to the agreement of the user to allow record companies to utilize the personal information of the user is stored in user selection data statistical analysis and storage with attribute data of user 405b and user selection data with personal information of the user 405a in music server 103. If the user decides to purchase the at least one song then the user selection data statistical analysis and storage with attribute data of user 405b or user selection data with personal information of the user 405a is sent through receiving mechanism 501b to record company server 105, depending on if the user has given an indication that record company server 105 can utilize personal information of the user.

If the user decides not to allow the record company to receive personal information, in 664, music server 103 through sending mechanism 403b transmits user selection data statistical analysis and storage with attribute data of user 405b through receiving mechanism 5017b to record company server 105. If the user decides to allow the record company to receive personal information then, in 664, music server 103 through sending mechanism 403b transmits user selection data with personal information of the user 405a selection data of the user through receiving mechanism 501b to record company server 105, then the process continues to 653. Thus, the user is able to receive requested information associated with at least one event in exchange for information on at least one user who receives the information associated with the at least one event.

In 661, if the at least one user decides to purchase the at least one song at a store, then mobile host 101 through sending mechanism 303a transmits a request for purchase of the at least one song with User ID. The user utilizes a special PAY button on a plurality of function buttons 205 to instruct mobile host 101 to purchase the at least one song. In 660, music server 103 through receiving mechanism 403a receives the request to purchase the at least one song with User ID. Music server 103 accepts the request to purchase the at least one song at the store or at least one store.

Music server 103 processes the request to purchase the at least one song and transmits the request to purchase the at least one song through sending mechanism 403a to, at 662, receiving mechanism 501b of record company server 105. Billing system mechanism 409a in communication with user database 405 inputs the request to purchase the at least one song or album or product from the store as a transaction between mobile host 101 and music server 103 in user database 405 and billing database 409.

In addition, music server 103 through billing system mechanism 409a charges a commission fee for record company server 105 for the purchase of the music file. If the user requests to purchase at least one product, then the record company server 105 is a server that processes the order through music server 103 by utilizing billing system mechanism 409a, billing database 409 and user database 405 to record the transaction. At this point, the transaction has been taken by billing system mechanism 409a and the record company server 105 through music server 103 may instruct the user of the mobile host 101 the location of at least one store where she can make the purchase of the at least one song or the at least one album or at least one product.

Billing system mechanism 409a may send a transcript of the transaction to at least one store where the user can pick up the at least one song, at least one album or the at least one product. Then the same transcript may be transmitted through sending mechanism 403b to receiving mechanism 303b of mobility host 101 that can be printed by mobility host 101. The user at mobility host 101 can utilize the transcript as a receipt to pick up the purchased song, album or product at the store.

In 663, the user must decide if she wants to continue searching for at least one additional song by utilizing the plurality of function buttons 205 or continue obtaining more information about the at least one song. If the one user decides to continue searching for the at least one song or another at least one song, then this software program or process returns to 601 to continue the process. If the user decides to continue obtaining more information about the at least one song then the process goes to 653. If the user decides to end this software program or process, then this process ends at 665.

It is therefore intended that the foregoing detailed description be regarded as illustrative rather than limiting, and that it be understood that it is the following claims, including all equivalents, that are intended to define the spirit and scope of this invention.

1. A method of retrieving information of at least one event, the method comprising:
recording at least one time period associated with at least one event from a schedule of a plurality of events;
monitoring the at least one event of the schedule of the plurality of events and updating at least one database with an unscheduled plurality of events that is combined with the schedule of the plurality of events to form a revised schedule of a plurality of events; and
selecting at least one parameter to retrieve requested information associated with at least one event from the updated at least one database.

2. The method of retrieving information of at least one event according to claim 1, wherein the at least one event is at least one television show.

3. The method of retrieving information of at least one event according to claim 1, wherein the at least one event is at least one radio show.

4. The method of retrieving information of at least one event according to claim 1, wherein the at least one parameter is selected from the group consisting of: at least one location area where the at least one event occurred and at least one type of service medium where the at least one event was broadcasted.

5. The method of retrieving information of at least one event according to claim 1, wherein the requested information associated with the at least one event is retrieved in exchange for information on at least one user who receives the information associated with the at least one event.

6. The method of retrieving information of at least one event according to claim 1, wherein the requested information associated with the at least one event is at least one electronic message.

7. A method of retrieving information of at least one event, the method comprising:
recording at least one time period associated with at least one event from a schedule of a plurality of events;
monitoring the at least one event of the schedule of the plurality of events and updating at least one database with an unscheduled plurality of events that is combined with the schedule of the plurality of events to form a revised schedule of a plurality of events; and
selecting at least one parameter to retrieve at least one electronic message from the updated at least one database.

8. A system for retrieving information on at least one event, the system comprising:
at least one first server having at least one database, wherein information associated with a schedule of a plurality of events is recorded on the at least one database;
at least one second server in connection with the at least one first server, wherein the at least one second server having at least one database that records the information associated with the schedule of the plurality of events and monitors the recorded information associated with the schedule of the plurality of events to update the at least one database with information associated with an unscheduled plurality of events that is combined with the recorded information associated with the schedule of the plurality of events to form a revised schedule of a plurality of events; and
at least one terminal in connection with the at least one first server, wherein the at least one terminal selects at least one parameter to retrieve requested information associated with at least one event from the update of the at least one database.

9. The system for retrieving information of at least one event according to claim 8, wherein the at least one terminal is at least one cellular phone.

10. The system for retrieving information of at least one event according to claim 8, wherein the at least one parameter is selected from the group consisting of: at least one location area where the at least one event occurred and at least one type of service medium where the at least one event was broadcasted.

11. The system for retrieving information of at least one event according to claim 8, wherein the connection between the at least one first server and the at least one second server is a wireless connection through at least one network.

12. The system for retrieving information of at least one event according to claim 8, wherein the connection between the at least one first server and the at least one terminal is a wireless connection through at least one network.

13. A terminal comprising:
means for recording at least one time period associated with at least one event from a schedule of a plurality of events; and
means for selecting at least one parameter to retrieve requested information associated with the at least one event.

14. A database comprising:
wherein the database records information associated with a schedule of a plurality of events and monitors the recorded information associated with the schedule of the plurality of events to update the at least one database with information associated with an unscheduled plurality of events that is combined with the recorded information associated with the scheduled plurality of events to form a revised schedule of a plurality of events.

15. A database comprising:
wherein the at least one database records information associated with a schedule of a plurality of events and monitors the recorded information associated with the schedule of the plurality of events to update the at least one database with information associated with an unscheduled plurality of events.

16. A method of retrieving information of at least one event, the method comprising:
recording at least one time period associated with at least one event from a schedule of a plurality of events; and
selecting at least one parameter to retrieve requested information associated with at least one event.

17. A method of retrieving information of at least one event, the method comprising:
recording at least one time period associated with at least one event from a schedule of a plurality of events;
monitoring the at least one event of the schedule of the plurality of events and updating at least one database with an unscheduled plurality of events; and
selecting at least one parameter to retrieve requested information associated with at least one event from the updated at least one database.

18. A system for retrieving information on at least one event, the system comprising:
at least one first server having at least one database, wherein information associated with a schedule of a plurality of events is recorded on the at least one database;
at least one second server in connection with the at least one first server, wherein the at least one second server having at least one database that records the information associated with the schedule of the plurality of events and monitors the recorded information associated with the schedule of the plurality of events to update the at least one database with information associated with an unscheduled plurality of events; and
at least one terminal in connection with the at least one first server, wherein the at least one terminal selects at least one parameter to retrieve requested information associated with at least one event from the updated at least one database.
